(19) United States
(12) Patent Application Publication
(10) Pub. No.: US 2019/0177142 A1
(43) Pub. Date: Jun. 13, 2019

(54) METHOD AF ALIGNING A WEIGH MODULE

(71) Applicant: Gerald S. Simons, Cambridge (CA)

(72) Inventor: Gerald S. Simons, Cambridge (CA)

(21) Appl. No.: 16/211,463

(22) Filed: Dec. 6, 2018

Related U.S. Application Data
(60) Provisional application No. 62/708,378, filed on Dec. 7, 2017.

(51) Int. Cl. B66F 9/12; G01G 19/18; G01G 19/08

(52) U.S. Cl. CPC B66F 9/12; G01G 19/083; G01G 19/18

(57) ABSTRACT

The invention provides a method of providing precise measurements and locations, for the retrofitting of a trolley having forks, with load cells, including the provision of covers attached over the load forks, and pre-drilled pilot holes in the covers corresponding to the precise locations required for load cell attachment.

This application is based on U.S. Provisional application Ser. No. 62/708,378, which was filed on Dec. 7, 2017, the priority of which is claimed.

### FIELD OF THE INVENTION

The invention relates to forklift equipment and in particular to a method of attaching load cells to the lifting forks.

### BACKGROUND OF THE INVENTION

Forklift vehicles and trolleys have been in use for many years. They operate simply on a principal that commercial goods are stacked on pallets. The pallets define spaces. The forks of the forklift vehicle are inserted into these spaces. The forks are then raised and the pallet load of commercial product or whatever must be moved, is then moved from place to place. One particular popular form of the forklift vehicle is the forklift hand-operated trolley. This is a simple 3 or 4-wheeled device with an operating handle. The device includes usually 2 forks. The operator simply steers the trolley by the handle until the forks are inserted into the pallet. The trolley is then operated for lifting the loaded pallet and moving it. Many other such trolleys are used for carrying other loads particularly, bins or product containers, known as “totes”. These are usually thermoplastic products, but may also be metal or wooden bins, which are used simply for carrying loads of some kind of product from place to place. These totes usually have legs, and are not usually placed on separate pallets. In many cases these totes define a greater space beneath the tote, than is available with the usual pallet. When lifting, the operator operates the controls on the handle. This may involve a simple swinging movement of the handle towards the operator. He can then drag the trolley with its load from place to place as required. Once at its destination the handle is operated so as to lower the forks and then remove them from the pallet, leaving the pallet standing on the floor. For various reasons, it is becoming desirable to include load cells on the forks. These load cells then provide a readout of the actual weight of the loaded pallet. Manufacturers of the original forklift trolleys can of course assist by fitting load cells. The owners of those forklift trolleys, who wish to have their trolleys retrofitted with load cells will be obliged to ship the entire trolley back to the manufacturer. The manufacturer then attaches the load cells and the necessary wiring and display panel, and then ships the trolley back to the owner. This is an expensive operation. Shipping of the trolley can be costly. While it is shipped out for retrofitting, it is not available to carry out the work in the owners premises. The end result is that the actual cost of retrofitting a trolley with load cells is almost equal to the cost of buying a new one equipped with load cells. Many owners of trolleys would like to be able to retrofit their existing forklift trolleys with load cells themselves. This reduces the costs substantially. The use of the trolley would be lost only for the time involved in retrofitting the load cells. Given a suitable kit of equipment, this retrofitting could probably be carried out within the space of 24 hours by service personnel at the premises of the owner.

Several improvements to this system are shown in U.S. Pat. Nos. 7,669,486; 8,955,393; 8,957,329 inventor: Gerald S. Simons and US patent application #2007/0041820 inventor: Gerald S. Simons and GB patent 2458848.

In the case of pallets used for lifting totes or other containers, the space beneath the tote is much greater than the space provided by a pallet. In this case it is preferable that the load cells be mounted on top of the forks rather than underneath. This arrangement is much easier and quicker for the owner to retrofit load cells. In addition, the load cells attached on top of the forks can be more robust, and provide greater accuracy.

In addition, the location of the load cells on top of the forks protects them from possible hazards due to objects or obstructions on the floor.

It is important that the load cells shall be attached to the forks at precise locations. Covers must also be attached on top of the forks. All of this must be done within a very limited space. The utility of the forklift vehicle for pallets is that the forks are placed low down and directed forward so that they can be inserted into spaces in the pallets. If the forks are substantially increased in height, then they become useless. Still another factor is that existing designs of most forklift trolleys include the forklift raising and lowering equipment underneath the forks themselves. This means that the space available for attaching load cells, to the underside of the forks, is limited. These spaces may vary from make to make of forklift vehicles.

To make the load cells effective with pallets, it is preferable that they be attached in the space beneath the loading forks. To function, the load cells must be bolted in position. In addition, the load cells incorporate upwardly projecting pressure members, which will extend through suitable openings in the loading forks, and will be then contacted by covers. In this way the weight of the pallet load on the covers is transferred to the load cells. The load cells then provide the electronic readout of the weight of the pallet load.

In most cases, the design of the loading forks is simply an inverted u-shaped channel.

The drilling of these various holes through the covers, and then through the loading forks themselves must be done with great precision.

Typically, the design of the load cell is based on a metal bar, to which two separate resistant wire patterns are bonded. When not under strain, the resistance of the two wire patterns is equal, and no current will flow. However, once the metal bar is placed under strain, the resistance of the two patterns changes, allowing power to flow. This form of load cell is well known and requires no further description. One end of the metal bar is held fixed, and the weight of the load is applied to the opposite end of the metal bar. The greater the weight, the more the metal bar is under strain. The greater the load, the greater the electronic readout from the metal bar. Thus typically, the load cell will require a minimum of 2 bolts at one end holding it fixed, and at the other end of the load cell, a pressure member is provided, to sense the load. For the purposes of this explanation and illustration, it is assumed that the load cells require this form of attachment. Thus each load cell will require two bolts at one end to bolt it either on top of, or under the fork. Where the load cell is located under the fork, a through opening must be provided in the fork, at the opposite end of the load cell, to allow the pressure member of each load cell to extend into contact with the load. In order to ensure that the pallet load weight is evenly shared between the load cells under the forks, covers are attached along the upper surface of each fork. These covers cover the pressure members of the various load cells.

An additional factor is that the covers which are added on top of the forks, must be secured to the forks. In many cases simply bolting covers directly to the pressure members will provide the accuracy required. In some cases, however, it is necessary to allow for slight movement of the cover relative to the pressure member of a load cell. When providing a kit to the owner of the trolley who wishes to retrofit his trolley with load cells, it is essential that the owner and his service personnel drill the various bolt holes through the covers and through the forks, at precise locations.

All of this must be achieved with a minimum of increase of the height of the forks so that the forks can still be readily inserted in the pallets, for the usual purpose of lifting the pallets.

### BRIEF SUMMARY OF THE INVENTION

The method according to the invention seeks to provide a series of steps, ensuring that these precise measurements and locations are provided. These method steps in one embodiment in which the load cells are to be attached underneath the forks of a trolley comprise; determining the design and construction of the pallet forks, and selecting the appropriate location for attachment of respective toe end and heel end load cells, creating covers to be attached over the surface of the load bearing forks, locating pre-drilled pilot holes in said covers corresponding to the precise locations required for load cell attachment in the design of forks selected, drilling through said pre-drilled openings pilot hole openings in said covers into said forks to form pilot holes through said forks, removing said covers, enlarging the bolt pilot holes in the forks for bolting said load cells in this position to the forks, enlarging the pilot hole in the forks for receiving the pressure members of each load cell, attaching pressure members to said load cells, each said pressure member extending through oversize openings in said forks, bolting said load cells under said forks, bolting said covers on top of said forks.

Where necessary, the method steps will also include providing spacers on said pressure members thereby establishing spacing between said covers and said load cells.

In another embodiment the method steps are essentially similar to those above with the exception that in this embodiment the load cells are to be attached on top of the forks and not underneath. In this embodiment, the steps will include providing spaces between said load cells and said forks, but will not include the requirement of drilling oversized openings in the forks to accept pressure members.

In some cases, the method steps will provide for attachment of the covers to the toe end of each fork, while leaving the heel end of each cover free of attachment, and the method steps will provide for heel ends of each cover to simply slide on top of a pressure member for the load cell(s) at the heel end. In this way the covers are free to move very slightly in a sliding fashion relative to the pressure members at the heel end of each fork.

In many cases, however, it is not necessary to provide this sliding function, and the covers can simply be bolted directly to the pressure members for respective load cells.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective view showing a typical hand operated trolley and forks;

FIG. 2 is a perspective, exploded view showing a trolley, and forks, and the components of the invention;

FIG. 3 is a top plan of the trolley of FIG. 1;

FIG. 4 is a side elevation view partly cut away of the trolley of FIG. 3;

FIG. 5 is a side elevation in section along line 5-5 of FIG. 4;

FIG. 6 is a side elevation in section along line 6-6 of FIG. 4;

FIG. 7 is a side section of a typical load cell;

FIG. 8 is a perspective of a typical load cell;

FIG. 9 is a top plan showing the covers in place;

FIG. 10 is a side elevation in section, corresponding to FIG. 6, showing an alternate embodiment.

### DESCRIPTION OF A SPECIFIC EMBODIMENT

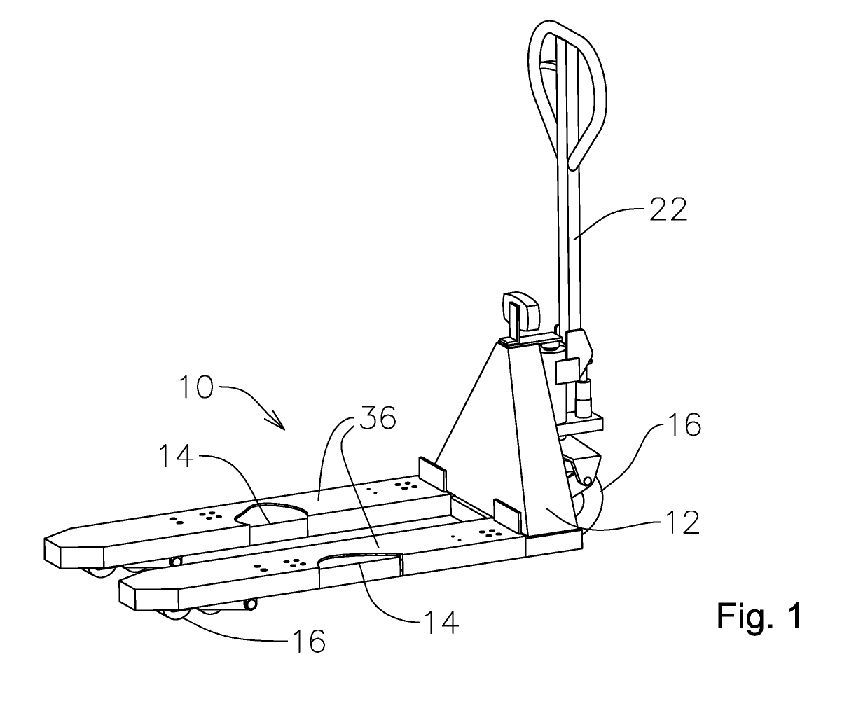

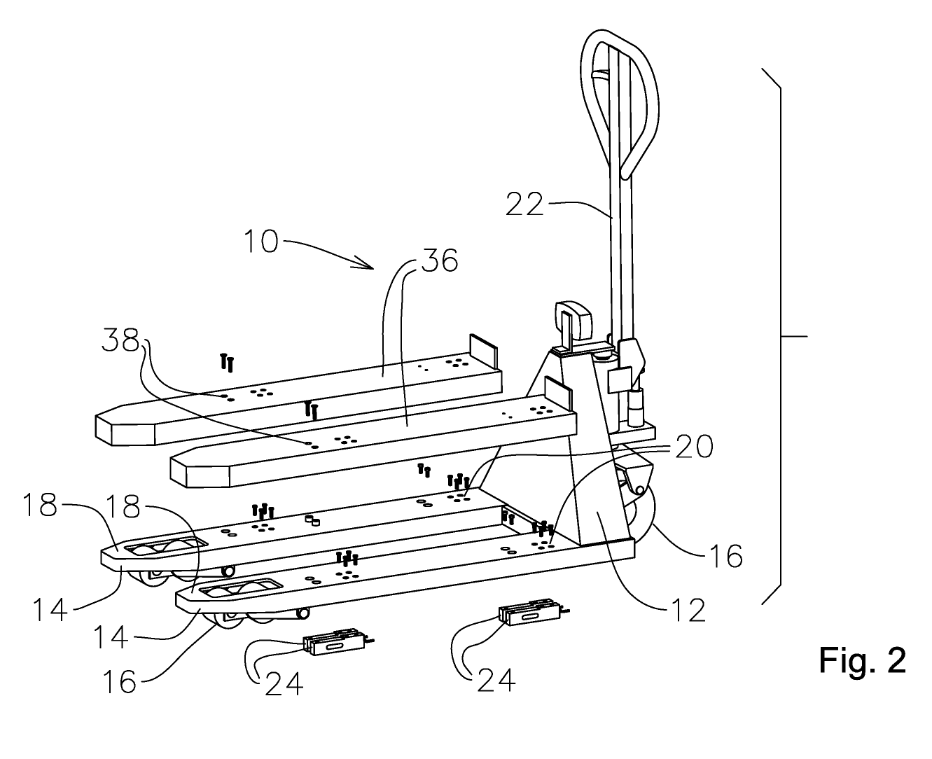

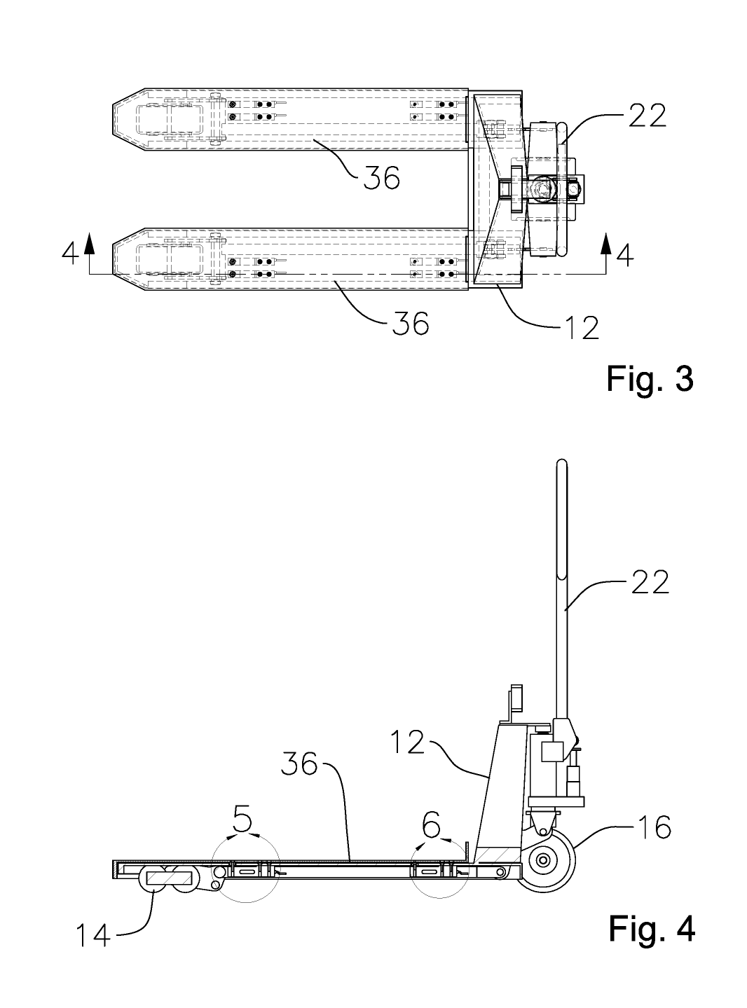

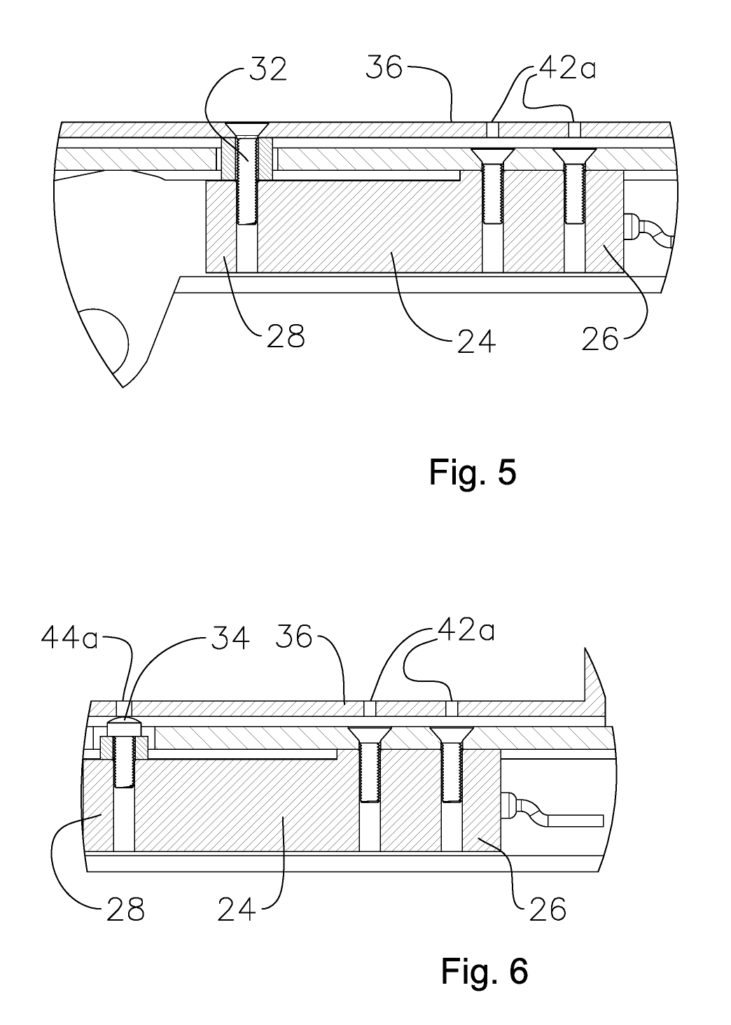

Referring to FIG. 1, it will be seen that this illustrates a typical trolley (10) of the type having a base (12), two forks (14), and wheels (16). The forks define toe ends (18) and heel ends (20).

A handle (22) extends from the base. The handle may be used for pulling and pushing a trolley, and for steering it so that the forks are guided under a pallet or a tote.

The forks typically can be raised or lowered by operation of the handle, which may have a mechanical system or hydraulic system (not shown) in the base for raising the forks. In some trolleys there may be an electrically powered system and batteries may be carried in the base. There are thus a wide variety of different trolleys of this type.

In addition to these hand trolleys, there are motorized trolleys, which may provide a seat for a driver, for example, with the forks extending forwardly.

Such motorized trolleys driven by a driver from a seat are in common use in the warehousing of goods. In these situations, the goods are warehoused on pallets or totes identified, for example, by universal product codes. A driver may wish to select goods from various different storage containers, with the forks simply extending under a box in the warehouse containing the desired product. Such motorized trolleys are known as “pickers”. The invention is thus applicable to any and all of these trolleys, in which forks are provided for lifting a heavy load of material. It is becoming desirable to provide a load sensing function in the forks so that the actual load of the product being carried on the forks is read out on the display panel.

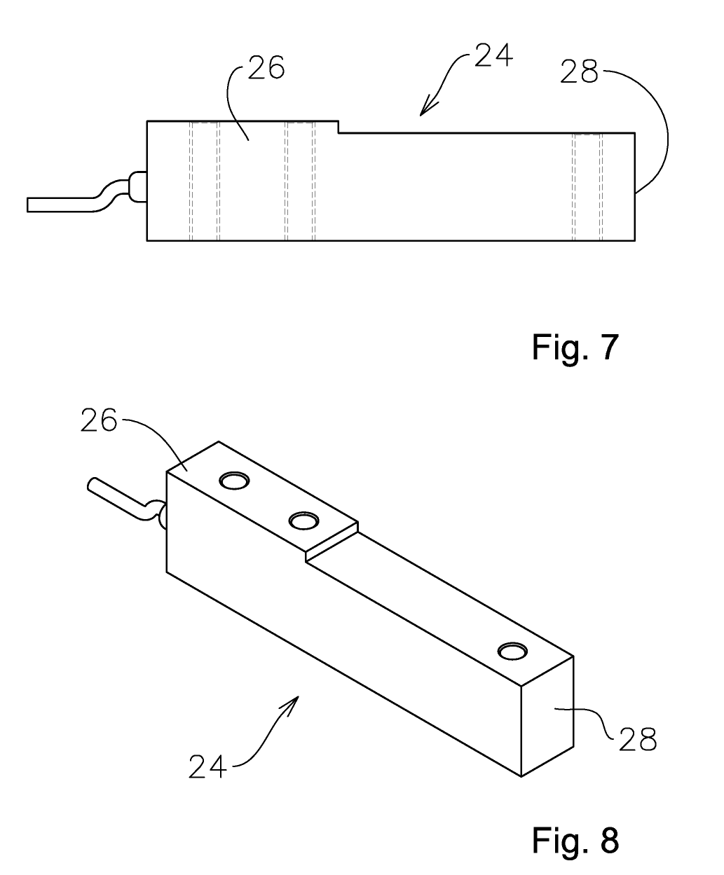

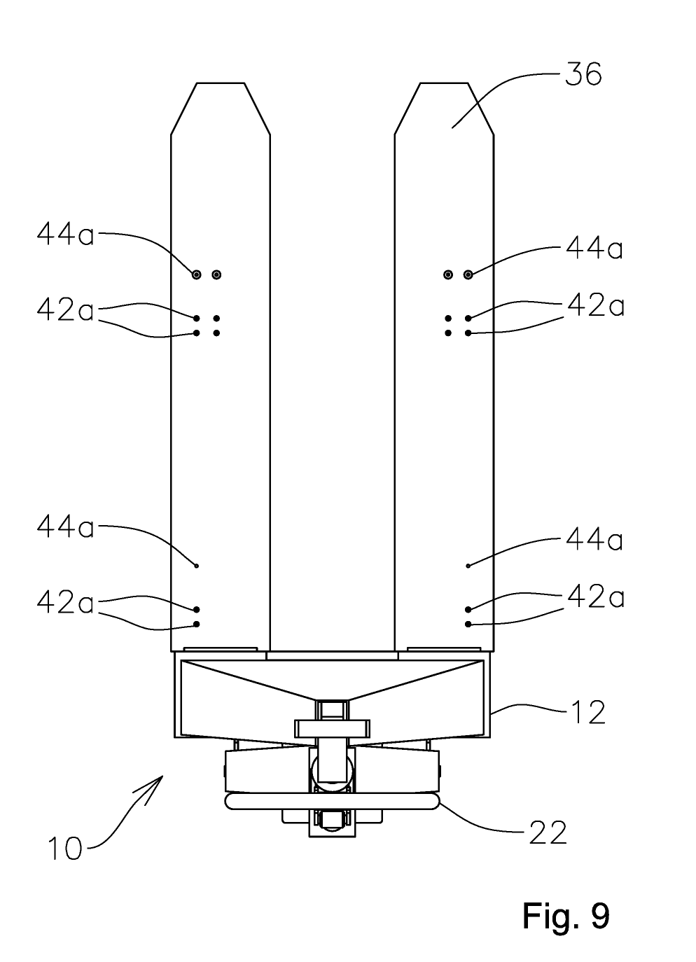

As stated above, the invention is directed towards a method of installing load sensing cells on such trolley forks, and to supplying a kit of parts by which the method can be carried out, usually at the premises of the owner of the trolley or forklift vehicle. In the case of the illustrated embodiment described here, the load cells are installed underneath the actual forks. However, the method steps are applicable to the installation of load cells on the upper surfaces of the forks, provided the forks are so designed as to permit this without drastically increasing their height. For the purposes of this explanation, a load cell (24) (FIGS. 7 and 8) consists simply of a metal bar defining two ends. One end (26) is bolted fixed to a support such as a fork of the forklift. The other end (28) is free. On the upper and under surfaces of the metal bar there are two wire formations (not shown) bonded. Equal voltages are applied to each of the wire formations, and when the metal bar is free of stress, no current will flow through the wires. However, once a stress is applied to the bar, then the two wire patterns function as what is called a Wheat Stone bridge. Current will be permitted in flow between the two wire patterns. This will provide a readout of the weight being applied to the metal bars to stress them.

In order to apply a load to a load cell, the free end of the bar is preferably provided with a pressure member. This member may be a simple bolt (30) which is secured through the metal bar. However, the bolt or pressure member may have a domed head (32) for reasons to be described below. In the case of the illustrated embodiment, there are four such load cells for each fork, two each at the toe end of the forks, and two each at the heel end of the forks. However, this is merely by way of illustration, in some cases there will be only three load cells per fork required. In the present case, an electronic display panel (not shown) is mounted on the base, on a suitable support so that the values can be read out by the operator. Suitable wiring, and battery power is provided, the details of which may vary from one design of forklift to another.

It will be appreciated that the location of the bolts required for securing the four load cells to each fork is of critical importance. It is desirable that this retrofitting of load cells to forklifts provides as little as possible change in the actual height of the forks. If the height of the forks increases significantly above the floor level, then they will not be able to be used for lifting many kinds of loads, especially loads on pallets. It will also be appreciated that the load cells and associated components will be supplied to the owner of the forklift. The steps required for the retrofitting of the load cells to the forks must therefor be as far as possible direct and straightforward, and capable of being explained with written instructions supplied with a kit. It will also be appreciated that the kit must ensure that not only the holes through each fork for bolting the various load cells in the exact position are provided, but also that a hole is drilled through each fork where the load cell pressure member will be required to pass through the fork, in order to sense any load applied on top of the fork.

It will be also seen that each fork of the forklift is provided with a cover (36) of a 3-sided channel shape in section defining respective side walls shrouding the fork of the forklift, and an upper wall extending between two side walls. Each cover will be fitted onto each fork of the forklift, over the upper surface of the fork. It may be desirable that the cover shall be capable of slight flexing, when a load is applied, and shall apply the weight of each load as far as possible equally to all four load cells. For this purpose, each cover (36), is more or less co-extensive with the length and width of the forks.

The cover is provided with fastening openings (38) which enable it to be bolted directly to the load cell pressure members on the fork itself at the toe ends of the forks. Again, it is important that these openings shall be located accurately. Once secured to the fork, the cover (36) will thus rest on the pressure members (32) or (34) of the load cells beneath the fork. The selection of the fastening locations for the cover, on the fork is necessary to ensure that when the cover is secured in position over the pressure members of the respective load cells, so that when the load is applied to the cover, the load is applied equally to all load cells. It is essential that this is carried out since otherwise the load cells will not provide an accurate reading of the weight of the product. There may be a slight flexing of the forks, from the weight of load. This may result in a very slight sliding movement between the pressure members of the load cells and the covers. By providing domed heads (34) on the pressure members at the heel end, it makes possible very slight movement of the cover relative to the load cell pressure member. This ensures that the pressure members shall not be displaced even by a slight movement of the cover, since the cover can slide relative to the domed head. In order to ensure that all of the holes drilled in each of the forks shall be precisely located, each of the covers (36) are pre-drilled with pilot holes for locating the holes to be drilled in each of the forks. Thus pilot holes (42a) will be drilled in the location of eventual pilot holes in the forks for the load cells.

In addition, pilot holes (44a) will be drilled in the covers (36) to locate the eventual pressure member pilot holes in the forks.

The covers are removed, and are shipped together with the load cells and the various nuts bolts, and electronic equipment to the customer.

When the customer receives the shipment of the kit, he will, first of all, check the covers by placing them on top of the forks of his trolley and then making sure that the height increase still allows the trolley to perform its normal function of lifting pallets.

The customer will then temporarily secure the covers to the forks using clamps. Using the pilot holes pre-drilled in the covers, the customer will then drill out load cell pilot holes in the forks. The directions to the customer will explain that the various pilot holes (42), will then be drilled out by him, to specific dimensions, suitable for attachment by bolts, supplied to the customer as a part of the kit. The customer will also drill out the pressure member pilot holes (44) in the forks. The customer will also drill out cover attachment holes in the cover. In this embodiment, these cover attachment holes will be seen to be located only at the toe end of each cover. The heel end of each cover remains unbolted, but, since the cover is attached at the toe end, it will be totally secure.

The customer will then attach the load cells at the heel end of each of the forks, with the pressure members of the respective load cells extending up through the pressure member openings in the forks.

It will also be seen that the enlarged holes drilled out to receive bolts are provided with frustoconical countersinks. The bolts supplied as a part of a kit will also be seen to have flat heads. In this way when the bolts are tightened up, the bolt heads will be flush with the fork, or indeed with the cover where at least the toe end of the cover is bolted to the pressure members.

The customer will then secure the load cells at the toe ends of each of the forks. The covers are then secured by passing bolts downwardly through the cover openings at the toe ends of each of the covers, the bolts passing through the load cell openings in the forks at the toe ends of the forks, and being secured directly into the pressure members of the respective load cells at the toe ends of the forks. When all are secured in place, then suitable wiring (not shown) will be connected between the load cells and the display panel, and suitable battery power will be secured on the base of the trolley, or in the display panel, and connected with the load cells, in the manner well-known in the art and requiring no special description.

In some cases, depending upon the actual thickness of the forks of the trolley, and other factors, the fitting of the load cells may require the addition of spacers to adjust the position of the load cells relative to the underside of the trolleys. Suitable spacers will be provided as part of the retrofitting kit.

The overall height of the forks and covers can also be adjusted by reducing the diameter of the wheels.

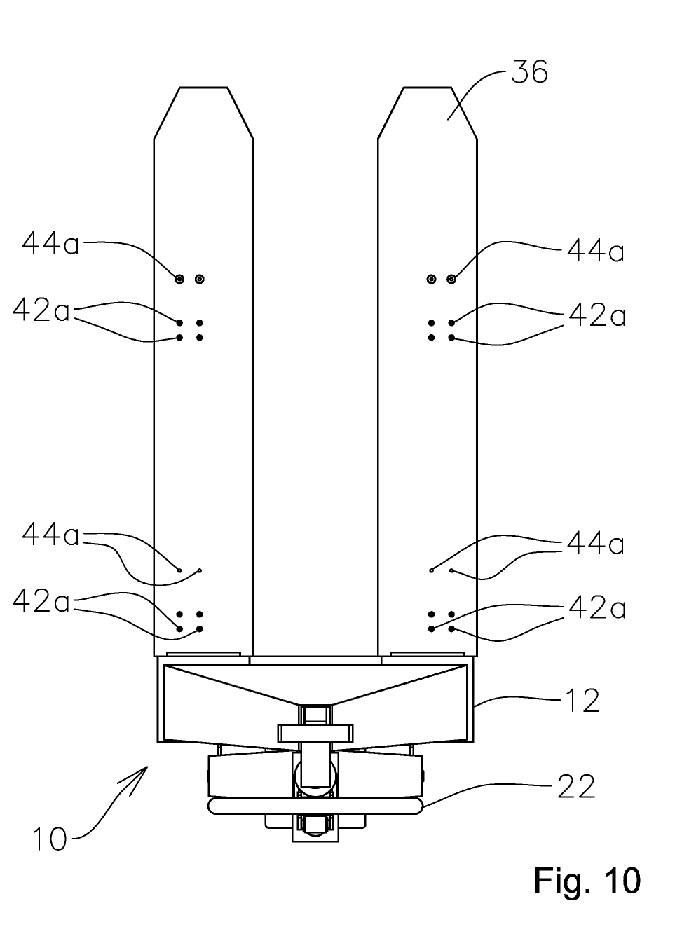

An alternate embodiment is shown in FIG. 10. In this embodiment there is no provision for sliding movement between the cover and the heel end load cells. In this case the heel ends of the covers are bolted down directly to the pressure members of the respective heel end load cells. This somewhat simplifies installation. It may be entirely adequate for cases where the loads are not excessive, or cases where the forks themselves are sufficiently strong that they are incapable of any flexing movement.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A method of precisely retrofitting load cells to be attached underneath the load bearing forks of a trolley wherein the load cells are of the type having pressure members for supporting a load and comprising the steps of:
determining the design and construction of the existing load bearing forks of said trolley;
selecting the appropriate location for attachment of load cells;
creating covers that enshroud the existing forks to be attached to the upper surface of the forks;
making cover pilot holes in said covers corresponding to the precise locations required for load cell attachment bolts and for pressure member openings in the design of forks selected;
placing said covers on said forks, and checking that the increase in height does not interfere with the usage of the trolley;
temporarily securing said covers to said forks;
drilling through said cover pilot holes into said forks, to form fork load cell pilot holes and fork pressure member pilot holes through said forks;
removing said covers from their respective said forks;
enlarging said fork load cell pilot holes for bolting said load cells in position under said forks;
enlarging said fork pressure member pilot holes for receiving pressure members of said load cells to form pressure member openings through said forks;
attaching pressure members to said load cells;
bolting said load cells under said forks, with said respective pressure members extending through said fork pressure member openings in said forks; and
bolting said covers on top of said forks overlying, and contacting said pressure members of respective said load cells.

2. A method of precisely retrofitting load cells to be attached underneath the load bearing forks of a trolley wherein said forks define toe ends at one end and heel ends at the other, and wherein there is at least one load cell attached to the toe end and at least one load cell attached to the heel end, wherein the load cells are of the type having pressure members for supporting a load and comprising the steps of:
determining the design and construction of the existing load bearing forks of said trolley;
selecting the appropriate location for attachment of load cells;
creating covers that enshroud the existing forks to be attached to the upper surface of the forks;
making cover pilot holes in said covers corresponding to the precise locations required for load cell attachment bolts and for pressure member openings in the design of forks selected;
placing said covers on said forks, and checking that the increase in height does not interfere with the usage of the trolley;
temporarily securing said covers to said forks;
drilling through said cover pilot holes into said forks, to form fork load cell pilot holes and fork pressure member pilot holes through said forks;
removing said covers from their respective said forks;
enlarging said fork load cell pilot holes for bolting said load cells in position;
drilling countersink recesses in said forks at said enlarged load cell bolt holes, for bolting said load cells to said forks by means of flat headed bolts whereby said bolts lie flush with the upper surface of respective said forks, and do not obstruct movement of said covers;
forming countersinks in said covers at said toe end pressure member holes;
enlarging said pressure member fork pilot holes for receiving pressure members of said load cells to form pressure member openings through said forks;
attaching toe end pressure members to said toe end load cells, said toe end pressure members passing through said toe end fork openings;
attaching heel pressure members to said heel load cells fitted with a dome shaped head, and wherein said dome shaped heads pass through said enlarged heel pressure member opening in said fork, to contact the underside of said cover;
bolting said load cells under said forks, with said respective pressure members extending through said pressure member openings in said forks; and
bolting said covers on top of said forks to said toe end pressure members, and contacting said pressure members of said heel end load cells.

3. A method of precisely retrofitting load cells to be attached underneath the load bearing forks of a trolley wherein said forks define toe ends at one end and heel ends at the other, and wherein there is at least one load cell attached to the toe end and another load cell attached to the heel end, wherein the load cells are of the type having pressure members for supporting a load and comprising the steps of:
determining the design and construction of the existing load bearing forks of said trolley;
selecting the appropriate location for attachment of load cells;
creating covers that enshroud the existing forks to be attached to the upper surface of the forks;
making cover pilot holes in said covers corresponding to the precise locations required for load cell attachment bolts and for pressure member openings in the design of forks selected;
placing said covers on said forks, and checking that the increase in height does not interfere with the usage of the trolley;
temporarily securing said covers to said forks;
drilling through said cover pilot holes into said forks, to form fork load cell pilot holes and fork pressure member pilot holes through said forks;
removing said covers from their respective said forks;
enlarging said fork load cell pilot holes for bolting said load cells in position;
drilling countersink recesses in said forks at said enlarged load cell bolt holes, for bolting said load cells to said forks by means of flat headed bolts whereby said bolts lie flush with the upper surface of respective said forks, and do not obstruct movement of said covers.
enlarging said pressure member fork pilot holes for receiving pressure members of said load cells to form pressure member openings through said forks;
drilling countersink recesses in said cover at said toe end pressure member holes, and drilling countersink recesses in said covers at said heel end pressure member holes;
attaching pressure members to said load cells passing through said enlarged pressure member openings in said forks, to contact the underside of said cover;
bolting said load cells under said forks, with said respective pressure members extending through said pressure member openings in said forks;
bolting said covers on top of said forks to said toe end pressure members; and,
bolting said covers on top of said forks to said heel end load cell pressure members.
